(19) United States
(12) Patent Application Publication
(10) Pub. No.: US 2026/0359875 A1
(43) Pub. Date: Nov. 12, 2026

(54) VISUAL TEMPLATE AND RECOMMENDATION SYSTEM

(71) Applicant: SAP SE, Walldorf (DE)

(72) Inventors: Arjun Rao, Fremont, CA (US); Nick Pendar, San Ramon, CA (US); Daniel Woo, Daly City, CA (US)

(21) Appl. No.: 19/199,457

(22) Filed: May 6, 2025

(51) Int. Cl. G06Q 30/0601; G06T 7/10; G06V 20/70

(52) U.S. Cl. CPC G06Q 30/0631; G06T 7/10; G06V 20/70; G06V 2201/07

(57) ABSTRACT

A visual template and recommendation system, for each reference image of a plurality of reference images, segments each reference image of the plurality of reference images to identify individual items within each reference image and analyzes, using a large language model, the identified individual items within each reference image to generate a textual description of the reference image. The visual template and recommendation system generates a set of vector embeddings by generating a vector embedding for each textual description of a respective reference image and creates a style template index based on the set of vector embeddings.

### BACKGROUND

In an online-shopping experience, product recommendation systems rely on a large volume of past transactional data to learn co-occurrence patterns of product purchases. In many cases, however, the transaction data is insufficient.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some examples.

FIG. 2 comprises a flow chart illustrating aspects of a method, according to some examples.

FIG. 3 illustrates an example image segmentation process, according to some examples.

FIG. 4 illustrates an example output textual description from an LLM for individual items for a given reference image, according to some examples.

FIG. 5 comprises a flow chart illustrating aspects of a method, according to some examples.

FIG. 6 is a block diagram illustrating an example of a software architecture that may be installed on a machine, according to some example embodiments.

FIG. 7 illustrates a diagrammatic representation of a machine, in the form of a computer system, within which a set of instructions may be executed for causing the machine to perform any one or more of the methodologies discussed herein, according to an example embodiment.

### DETAILED DESCRIPTION

A visual template and recommendation system is described herein that generates a textual description for each of a plurality of reference images to generate a style template index based on vector embeddings of textual descriptions. The style template index is used to identify a style template relevant to a user query to identify items from a product catalog to recommend in response to the user query. This system addresses significant technical problems in recommendation systems as further explained next.

Conventional product recommendation systems rely on a large volume of past transactional data to learn co-occurrence patterns of product purchases. This is problematic where there is limited purchase data. Moreover, items that are purchased together do not necessarily correlate to an aesthetically pleasing style or the items may be purchased for different users, such as a blouse for a mother and a sun dress for a child. Furthermore, trends change quickly which would not be reflected in past transactional data. For instance, new items lack sufficient interaction data.

There are further technical problems in recommendation systems that wish to use large language models (LLMs), such as ChatGPT, to make style recommendations. While LLMs can make general style recommendations, these LLMs cannot maintain consistent style rules specific to a brand or design philosophy, resulting in inconsistent and unreliable recommendations.

To address these and other technical problems, the visual template and recommendation system, for each reference image of a plurality of reference images, segments using an image processing segmentation technique, each reference image of the plurality of reference images to identify individual items within each reference image and analyzes, using a large language model, the identified individual items within each reference image to generate a textual description of the reference image. The visual template and recommendation system generates a set of vector embeddings by generating a vector embedding for each textual description of a respective reference image and creates a style template index based on the set of vector embeddings. When the visual template and recommendation system receives a query from a user device in at least one of a text format, an audio format, or an image format, the computing system coverts the query to a query vector embedding, analyzes, by the large language model, the query vector embedding to identify at least one matching style template in the style template index, and identifies items from a product catalog that correspond to items in the at least one matching style template. The visual template and recommendation system causes the identified items to be displayed on the user device as a personalized recommendation in response to the query.

In this way, the visual template and recommendation system enables a system to match across multiple domains (e.g., fashion, décor) while maintaining style consistency. Further this solution supports image to image retrieval, text to image retrieval, or audio to image retrieval, making the system more natural and versatile.

Furthermore, the visual template and recommendation system addresses the technical challenge of vendor-specific style consistency by creating indexes for particular vendors, constraining style recommendations to align with a specific vendor's aesthetic. This allows the visual template and recommendation system to adapt quickly to new trends without requiring extensive purchase history data, making it particularly valuable for smaller e-commerce sites that lack the traffic volume of larger platforms. The visual template and recommendation system's architecture enables fast, consistent results since the results are based on pre-validated matches, while leveraging AI's natural language understanding capabilities to provide a more intuitive user experience.

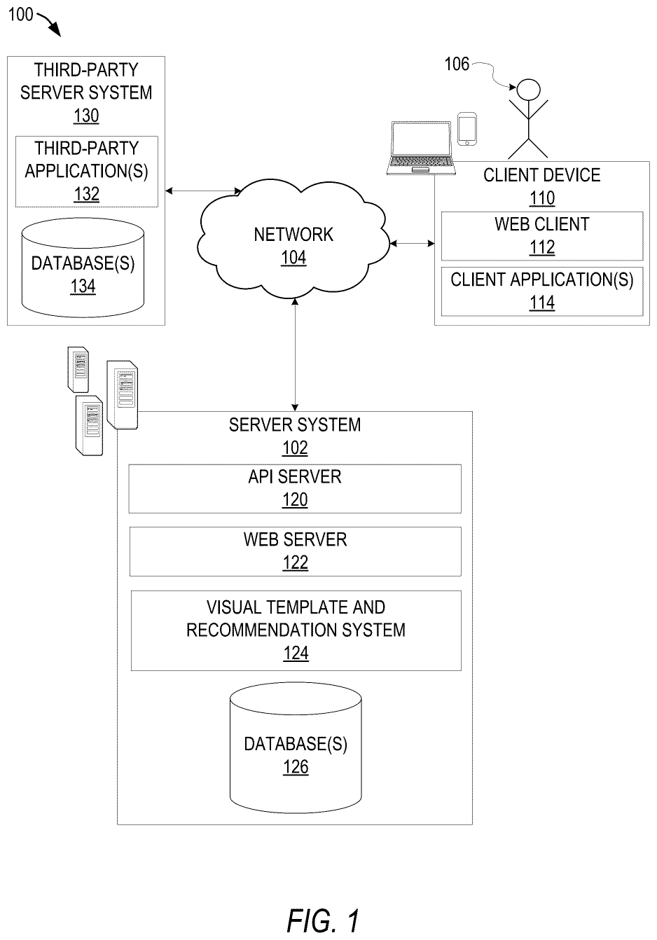

FIG. 1 is a block diagram illustrating a networked system 100, according to some example embodiments. The system 100 can include one or more client devices such as client device 110. The client device 110 comprises, but is not limited to, a mobile phone, desktop computer, laptop, portable digital assistants (PDA), smart phone, tablet, Ultrabook, netbook, laptop, multi-processor system, microprocessor-based or programmable consumer electronic, game console, set-top box, computer in a vehicle, wearable computing device, or any other computing or communication device that a user may utilize to access the networked system 100. In some embodiments, the client device 110 comprises a display module (not shown) to display information, such as in the form of user interfaces. In further embodiments, the client device 110 comprises one or more of touch screens, accelerometers, gyroscopes, cameras, microphones, global positioning system (GPS) devices, and so forth. The client device 110 may be a device of a user 106 that is used to access and utilize cloud services, utilize a visual template and recommendation system 124, among other applications.

One or more users 106 may be a person, a machine, or other means of interacting with the client device 110. In example embodiments, the user 106 may not be part of the system 100 but may interact with the system 100 via the client device 110 or other means. For instance, the user 106 can provide input (e.g., touch screen input or alphanumeric input) to the client device 110 and the input can be communicated to other entities in the system 100 (e.g., third-party server system 130, server system 102) via the network 104. In this instance, the other entities in the system 100, in response to receiving the input from the user 106, communicate information to the client device 110 via the network 104 to be presented to the user 106. In this way, the user 106 can interact with the various entities in the system 100 using the client device 110.

The system 100 further includes a network 104. One or more portions of network 104 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the public switched telephone network (PSTN), a cellular telephone network, a wireless network, a WiFi network, a WiMax network, another type of network, or a combination of two or more such networks.

The client device 110 can access the various data and applications provided by other entities in the system 100 via web client 112 (e.g., a browser, such as the Internet Explorer® browser developed by Microsoft® Corporation of Redmond, Washington State) or one or more client applications 114. The client device 110 can include one or more client applications 114 (also referred to as “apps”) such as, but not limited to, a web browser, a search engine, a messaging application, an electronic mail (email) application, an e-commerce site application, a mapping or location application, an enterprise resource planning (ERP) application, a customer relationship management (CRM) application, an application for accessing and utilizing a visual template and recommendation system 124, and the like.

In some embodiments, one or more client applications 114 is included in a given client device 110, and configured to locally provide the user interface and at least some of the functionalities, with the client application(s) 114 configured to communicate with other entities in the system 100 (e.g., third-party server system 130, server system 102, etc.), on an as-needed basis, for data and/or processing capabilities not locally available (e.g., access location information, access machine learning models, to authenticate a user 106, to verify a method of payment, access an intelligent styling system 124, and so forth), and so forth. Conversely, one or more client applications 114 may not be included in the client device 110, and then the client device 110 can use its web browser to access the one or more applications hosted on other entities in the system 100 (e.g., third-party server system 130, server system 102).

A server system 102 provides server-side functionality via the network 104 (e.g., the Internet or wide area network (WAN)) to one or more third-party server system 130 and/or one or more client devices 110. The server system 102 can include an application program interface (API) server 120, a web server 122, and an intelligent styling system 124 that can be communicatively coupled with one or more databases 126.

The one or more databases 126 are storage devices that store data related to users of the system 100, applications associated with the system 100, cloud services, machine learning models, parameters, and so forth. The one or more databases 126 can further store information related to third-party server system 130, third-party applications 132, third-party database(s) 134, client devices 110, client applications 114, users 106, and so forth. In one example, the one or more databases 126 is cloud-based storage.

The server system 102 can be a cloud computing environment, according to some examples. The server system 102, and any servers associated with the server system 102, can be associated with a cloud-based application, in some examples.

The visual template and recommendation system 124 provides back-end support for third-party applications 132 and client applications 114, which can include cloud-based applications. The visual template and recommendation system 124 provides for generating a style template index (e.g., for an online marketplace) and related functionality, as explained in further detail below. The visual template and recommendation system 124 can comprise one or more servers or other computing devices or systems.

The system 100 further includes one or more third-party server system 130. The one or more third-party server system 130 can include one or more third-party application(s). The one or more third-party application(s) 132, executing on third-party server(s) 130, can interact with the server system 102 via API server 120 via a programmatic interface provided by the API server 120. For example, one or more of the third-party applications 132 can request and utilize information from the server system 102 via the API server 120 to support one or more features or functions on a website hosted by the third party or an application hosted by the third party.

The third-party website or application 132, for example, can provide access to functionality and data supported by third-party server system 130. In one example embodiment, the third-party website or application 132 can provide access to functionality that is supported by relevant functionality and data in the third-party server system 130. In another example, a third-party server system 130 is a system associated with an entity that accesses cloud services via server system 102.

The third-party database(s) 134 are storage devices that store data related to users of the third-party server system 130, applications associated with the third-party server system 130, cloud services, machine learning models, parameters, and so forth. The one or more databases 134 can further store information related to third-party applications 132, client devices 110, client applications 114, users 106, and so forth. In one example, the one or more databases 134 is cloud-based storage.

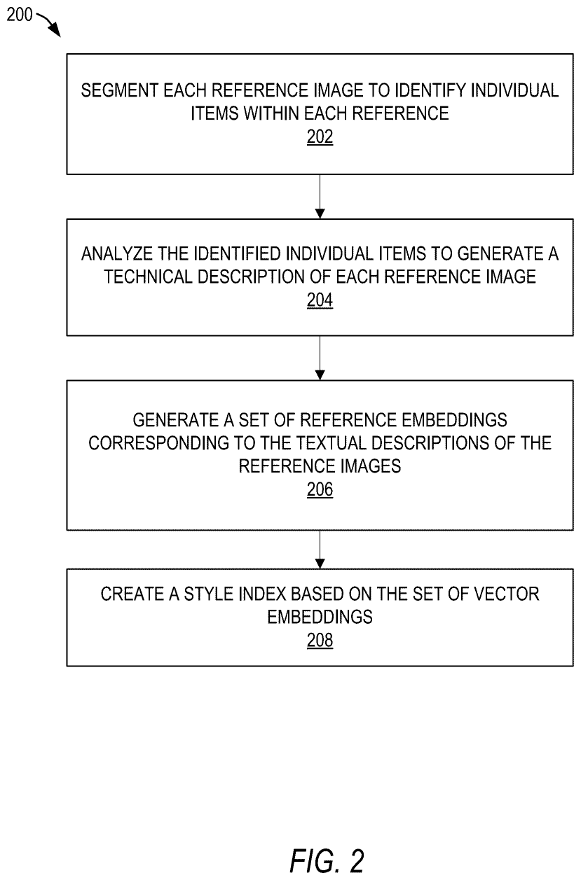

FIG. 2 is a flow chart illustrating aspects of a method 200 for generating a style template index based on reference images, according to some example embodiments. For illustrative purposes, method 200 is described with respect to the block diagram of FIG. 1. It is to be understood that method 200 may be practiced with other system configurations in other embodiments.

In operation 202, a computing system (e.g., server system 102 or visual template and recommendation system 124), segments each reference image of a plurality of reference images to identify individual items within each reference image. In one example, the computing system segments each reference image into a plurality of individual items (e.g., images) using an image processing segmentation technique. For example, the computing system accesses images from at least one public source of images, such as a merchant catalog, a social media source (e.g., Instagram, Pinterest), a website, or other public source of images. An example merchant catalog includes a clothing, accessory, home décor, or other product catalog. An example social media source or website includes a social media source or website that is related to clothing, accessories, home décor or other products and contains images of such products. The images in the public source of images may contain a fashion model wearing a particular outfit, a living room styled in a particular way, an arrangement of clothes and accessories, or other product scenarios. In one example, the computing system accesses the at least one public source of images at one or more third-party server system 130 or database(s) 134, or other system or database(s) via a network 104.

For each reference image of the plurality of reference images, the computing system segments the image, using an image processing segmentation technique, into different items to generate segments for the image. For example, an image may contain more than one product and thus, can be segmented into different parts of the fashion or décor shown in the image. Any image processing technique can be used to generate segments for an image, such as mask R-CNN, a service such as Clarifai, or an OWL-V2 model.

In one example, a machine learning model (such as mask R-CNN) is trained using labeled data to segment objects in an image. The trained machine learning model is then used to analyze an image and output a bounding box for each object recognized in the image. Each segmented object can be stored (e.g., in one or more database(s) 126) as a separate image while maintaining its relationship to the original outfit.

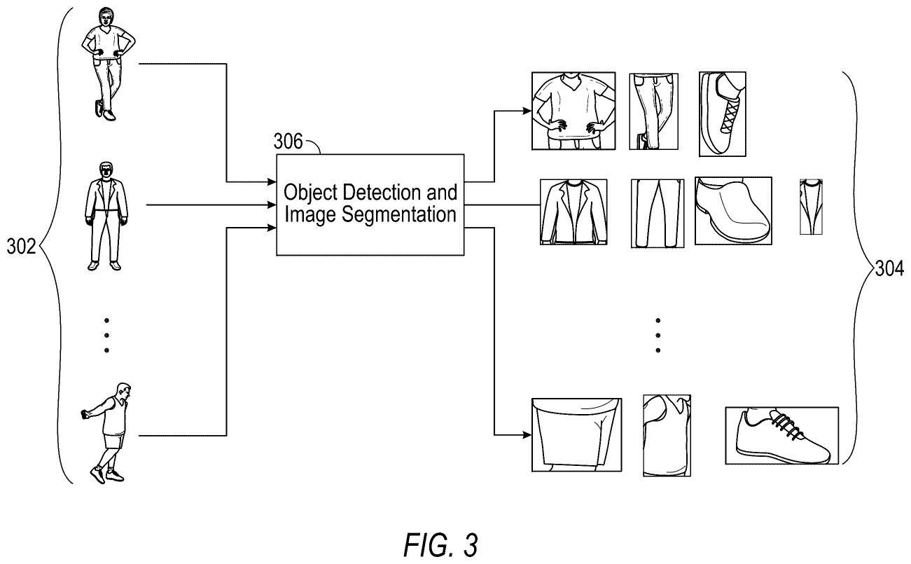

FIG. 3 shows an example image segmentation process. In this example the computing system accesses reference images 302 which are input into an object detection and image segmentation system 306. The object detection and image segmentation system 306 outputs segmented images 304. Specifically, the computing system, using the object detection and image segmentation system 306, outputs individual items, or individual (segmented) images 304, for each reference image 302.

Returning to FIG. 2, the computing system analyzes, using a large language model (LLM), the identified individual items within each reference image to generate a textual description of the reference image, in operation 204. Examples of LLMs include GPT-4o, GPT-4 vision, Claude 3, Gemini 2.5, LLaVa, Qwen-VL, or the like.

For example, the LLM is prompted to generate predefined categories for the textual description including at least one of a style category, an occasion category, a season category, a color category, a style element category, a complementary items category, a style name category, or other category. Accordingly, the individual items for each reference image are provided as input into the LLM with a prompt to generate the textual description including at least one predefined category. In this way the computing system can control for consistency and quality of the output of the LLM.

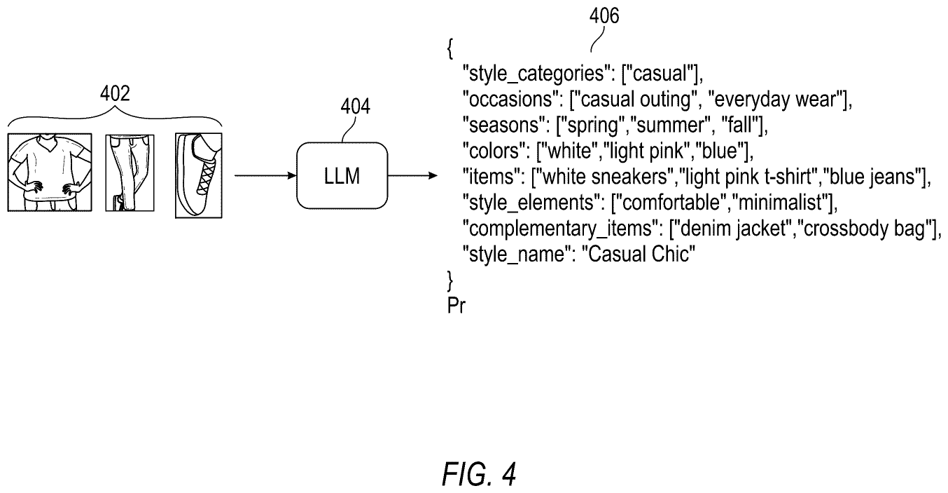

FIG. 4 illustrates an example output textual description 406 from an LLM 404 for individual items 402 for a given reference image. In this example the individual items (images) 402 are input into the LLM 404 with a prompt, as described above. The LLM 404 analyzes the image and output the textual description 406 according to the prompt. In this example, the textual description 406 comprises predefined categories that include style_categories, occasions, seasons, colors, items, style_elements, complementary_items and style_name. For each of these categories the LLM 404 has generated text corresponding to the individual items 402, such as a text description of “casual” for the style_category, a description including “casual outing” and “everyday wear” for occasions, and so forth.

Accordingly, for each reference image of a plurality of reference images, the computing system segments, using an image processing segmentation technique, each reference image of the plurality of reference images to identify individual items within each reference image, and then analyzes, using a large language model, the identified individual items within each reference image to generate a textual description of the reference image.

Returning to FIG. 2, in operation 208, the computing system generates a set of vector embeddings by generating a vector embedding for each textual description of a respective reference image. A vector embedding is a numerical vector representation of the textual description. Any vector embedding technique can be used to generate the numerical vector representation, such as Word2Vec, GloVe, BERT, or the like.

Optionally, the computing system can also generate a vector embedding of each image corresponding to each identified individual item within each reference image. Any image embedding technique can be used to generate the numerical vector representation, such as ResNet50, VGG-16, InceptionV3, EfficientNet, or the like. An image embedding is a numerical vector representation of an image. In this case, the computing system generates the vector embedding for each textual description and a vector embedding for each image corresponding to each identified individual item within each reference image. In some examples, one vector embedding is generated based on the textual description and each image. In other examples, a separate vector embedding is generated for each of the textual description and each image.

In some examples, the computing system employs a pre-trained ResNet50 model (e.g., with ImageNet weights and global average pooling) to extract meaningful feature representations for each segmented image. For example, the computing system loads each segmented image, resizes it to 224×224 pixels to match ResNet50's input requirements, applies appropriate preprocessing (e.g., mean subtraction, scaling), passes the processed through the ResNet50 model, and extracts the feature vector (vector embedding) from the global average pooling layer. This feature extraction process produces rich, high-dimensional representation of each segmented image that captures key visual characteristics including color, texture, pattern, and shape.

In operation 210, the computing system creates a style template index based on or comprising the set of vector embeddings. In some examples, the style template index contains style templates associated with a particular vendor's or merchant's products.

In some examples, the style template index comprises embeddings of item groups, where each embedding represents a curated set of products, such as an outfit or coordinated bundle. Each product set such as [blue shirt, white pants, black shoes] is jointly encoded into a single vector using a sentence or set encoder. These embeddings are stored in an approximate nearest neighbor (ANN) index such as Annoy, FAISS or the like. For instance:
[blue shirt, white pants, black shoes]→single embedding →index entry 1
[skirt, red heels, necklace]→single embedding →index entry 2

[symbol]

The computing system stores the style template index in one or more datastore such as database(s) 126 or databases(s) 134. At inference time, the computing system embeds the user query or context, retrieves the most similar product sets, and supplies the corresponding items as context to the LLM for response generation, as explained further below.

The style template index can be updated on a periodic basis as new trends and styles come out. For example, the computing system can monitor one or more public sources of images for any new images or get alerts for new images from the one or more public sources. Once the computing system detects new images from at least one public source of images, the computing system can update the style template index based on the new images, as explained above with respect to operations 202-208.

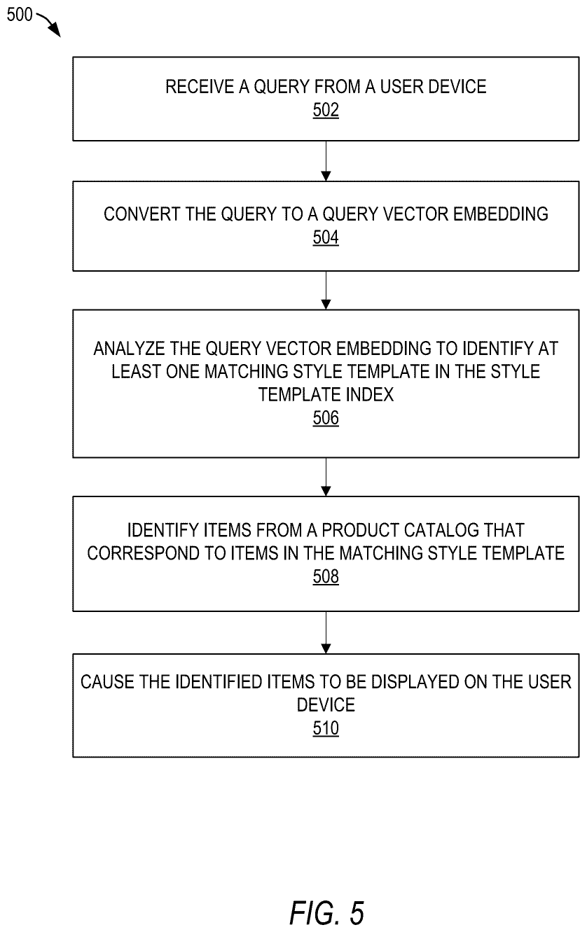

FIG. 5 is a flow chart illustrating aspects of a method 500 for generating a response to a user query based on the style template index, according to some example embodiments. For illustrative purposes, method 500 is described with respect to the block diagram of FIG. 1. It is to be understood that method 500 may be practiced with other system configurations in other embodiments.

In operation 502, the computing system receives a query from a user device. The query can be in at least one of a text format, an audio format, or an image format. The query can include a request for items appropriate for a specified occasion and the identified items are associated with the specific occasion. For example, a user can input a query into the user device asking, “what goes well with a light pink shirt” or “what is a casual outfit I can wear to a barbeque.”

In operation 504, the computing system converts the query to a query embedding. A query embedding is a vector embedding that can be generated as explained above with respect to FIG. 2.

In operation 506, the computing system analyzes the query vector embedding to identify at least one matching style template in the style template index. For instance, the computing system compares the query vector embedding to the vector embeddings in the style template index to identify one or more matching style templates. In some examples, the computing system selects a template with a highest overall similarity score.

In operation 508, the computing system identifies items from a product catalog that correspond to items in the at least one matching style template. In some examples, the product catalog is associated with a specific vendor and the personalized recommendation is limited to products available from the specific vendor. The product catalog can be stored in one or more datastores, such as database(s) 126 or database(s) 134. The product catalog comprises a plurality of items (products) that are available for purchase form the specific vendor. The computing system identifies items from the product catalog that correspond to items in the at least one matching style template using cosine similarity or similar technique.

In some examples, to enable efficient retrieval and matching, the computing system constructs an indexed representation of the product catalog (e.g., a merchant catalog index). For instance, the computing system reads the product catalog data from a JSON file containing outfit sets and item indices, and, for each item in the product catalog, the computing system extracts its ResNet50 embedding. The computing system stores these embeddings in a dictionary with keys that preserves the relationships between items and their outfit sets and builds an efficient search index using the Annoy (Approximate Nearest Neighbors Oh Yeah) library which enables fast similarity searches with a configurable trade-off between speed and accuracy.

In operation 510, the computing system causes the identified items to be displayed on the user device as a personalized recommendation in response to the query. In one example, the computing system passes the identified items as context to the LLM. The LLM interprets the context and generates a response to the user query to be displayed on the user device.

For example, if a user input “what goes well with a light pink shirt” the computing system would cause a response to be displayed on a display of the user device, such as an outfit with a light pink shirt, jeans, white sneakers, and a crossbody bag. In other examples, individual items can be displayed, a textual response, or other method for conveying a style recommendation based on the identified items. Further, the items, outfit, or aspects of the images can be linked to a specific product that can be purchased by the user. For instance, each item, the outfit, or other display items can be selectable. Upon detecting selection of one or more items, the computing system can cause further details to be displayed about the item, options for purchasing the item, and so forth. In this way, the LLM is constrained with styling that goes well with products from a particular merchant (e.g., ABC clothing company) and the user can directly purchase recommended items.

In some examples, the computing system prompts the LLM to assess the compatibility of the recommended outfit. For each item, the LLM assigns a compatibility score, such as a score between 1-5 and provides an explanatory note, enabling users to understand the rationale behind the assessment. For example, if the if the template features pastel summer attire, the LLM may praise a recommended cream blazer for harmonizing with the pastel palette, but critique heavy boots as incongruent with the season's light, airy theme. These explainable, context-rich assessments stand in stark contrast to opaque numeric metrics, increasing user trust and interpretability.

In view of the above disclosure, various examples are set forth below. It should be noted that one or more features of an example, taken in isolation or combination, should be considered within the disclosure of this application.
Example 1. A computer-implemented method comprising:
   for each reference image of a plurality of reference images, performing operations comprising:
      segmenting, using an image processing segmentation technique, each reference image of the plurality of reference images to identify individual items within each reference image; and
      analyzing, using a large language model, the identified individual items within each reference image to generate a textual description of the reference image;
   generating a set of vector embeddings by generating a vector embedding for each textual description of a respective reference image;
   creating a style template index based on the set of vector embeddings;
   receiving a query from a user device in at least one of a text format, an audio format, or an image format;
   converting the query to a query vector embedding;
   analyzing the query vector embedding to identify at least one matching style template in the style template index;
   identifying items from a product catalog that correspond to items in the at least one matching style template; and
   causing the identified items to be displayed on the user device as a personalized recommendation in response to the query.
Example 2. A computer-implemented method according to any of the previous examples, wherein the textual description includes at least one of a style category, occasion, season, or color.
Example 3. A computer-implemented method according to any of the previous examples, wherein the large language model is prompted to generate predefined categories for the textual description including at least one of a style category, an occasion category, a season category, a color category, a style element category, a complementary items category, or a style name category.
Example 4. A computer-implemented method according to any of the previous examples, wherein the style template index contains style templates associated with a particular vendor's products.
Example 5. A computer-implemented method according to any of the previous examples, wherein the product catalog is associated with a specific vendor and the personalized recommendation is limited to products available from the specific vendor.
Example 6. A computer-implemented method according to any of the previous examples, wherein the query includes a request for items appropriate for a specified occasion and the identified items are associated with a specific occasion.
Example 7. A computer-implemented method according to any of the previous examples, wherein identifying items from a product catalog that correspond to items in the at least one matching style template is performed using cosine similarity.
Example 8. A computer-implemented method according to any of the previous examples, wherein analyzing, using a large language model, the identified individual items within each reference image to generate a textual description of the reference image comprises:
   providing the identified individual items as input to the large language model; and
   prompting the large language model with predefined categories to generate the textual description.
Example 9. A computer-implemented method according to any of the previous examples, further comprising:
   generating a vector embedding of each image corresponding to each identified individual item within each reference image; and
   wherein generating the vector embedding for each textual description of a respective reference image comprises generating the vector embedding for each textual description and a vector embedding for each image corresponding to each identified individual item within each reference image.
Example 10. A computer-implemented method according to any of the previous examples, wherein one vector embedding is generated based on the textual description and each image.
Example 11. A computer-implemented method according to any of the previous examples, wherein a separate vector embedding is generated for each of the textual description and each image.
Example 12. A system comprising:
   a memory that stores instructions; and
      one or more processors configured by the instructions to perform operations comprising:
   for each reference image of a plurality of reference images, performing operations comprising:
      segmenting, using an image processing segmentation technique, each reference image of the plurality of reference images to identify individual items within each reference image; and
      analyzing, using a large language model, the identified individual items within each reference image to generate a textual description of the reference image;
   generating a set of vector embeddings by generating a vector embedding for each textual description of a respective reference image;
   creating a style template index based on the set of vector embeddings;
   receiving a query from a user device in at least one of a text format, an audio format, or an image format;
   converting the query to a query vector embedding;
   analyzing the query vector embedding to identify at least one matching style template in the style template index;
   identifying items from a product catalog that correspond to items in the at least one matching style template; and
   causing the identified items to be displayed on the user device as a personalized recommendation in response to the query.
Example 13. A system according to any of the previous examples, wherein the textual description includes at least one of a style category, occasion, season, or color.
Example 14. A system according to any of the previous examples, wherein the large language model is prompted to generate predefined categories for the textual description including at least one of a style category, an occasion category, a season category, a color category, a style element category, a complementary items category, or a style name category.
Example 15. A system according to any of the previous examples, wherein the style template index contains style templates associated with a particular vendor's products.
Example 16. A system according to any of the previous examples, wherein the product catalog is associated with a specific vendor and the personalized recommendation is limited to products available from the specific vendor.
Example 17. A system according to any of the previous examples, wherein the query includes a request for items appropriate for a specified occasion and the identified items are associated with a specific occasion.
Example 18. A system according to any of the previous examples, wherein identifying items from a product catalog that correspond to items in the at least one matching style template is performed using cosine similarity.
Example 19. A system according to any of the previous examples, wherein analyzing, using a large language model, the identified individual items within each reference image to generate a textual description of the reference image comprises:
   providing the identified individual items as input to the large language model; and
   prompting the large language model with predefined categories to generate the textual description.
Example 20. A non-transitory computer-readable medium comprising instructions stored thereon that are executable by at least one processor to cause a computing device to perform operations comprising:
   for each reference image of a plurality of reference images, performing operations comprising:
      segmenting, using an image processing segmentation technique, each reference image of the plurality of reference images to identify individual items within each reference image; and
      analyzing, using a large language model, the identified individual items within each reference image to generate a textual description of the reference image;
   generating a set of vector embeddings by generating a vector embedding for each textual description of a respective reference image;
   creating a style template index based on the set of vector embeddings;
   receiving a query from a user device in at least one of a text format, an audio format, or an image format;
   converting the query to a query vector embedding;
   analyzing the query vector embedding to identify at least one matching style template in the style template index;
   identifying items from a product catalog that correspond to items in the at least one matching style template; and
   causing the identified items to be displayed on the user device as a personalized recommendation in response to the query.

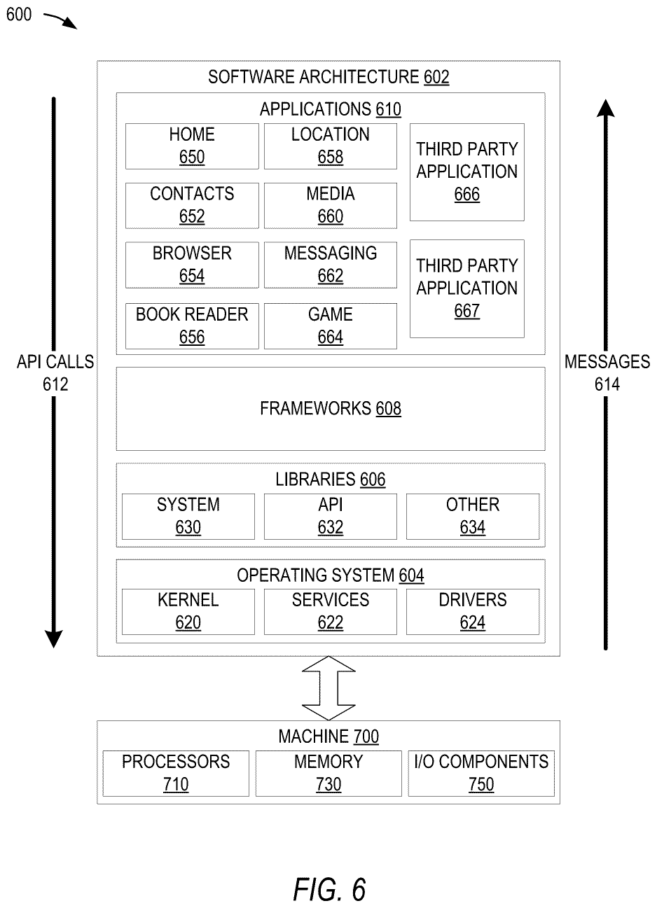

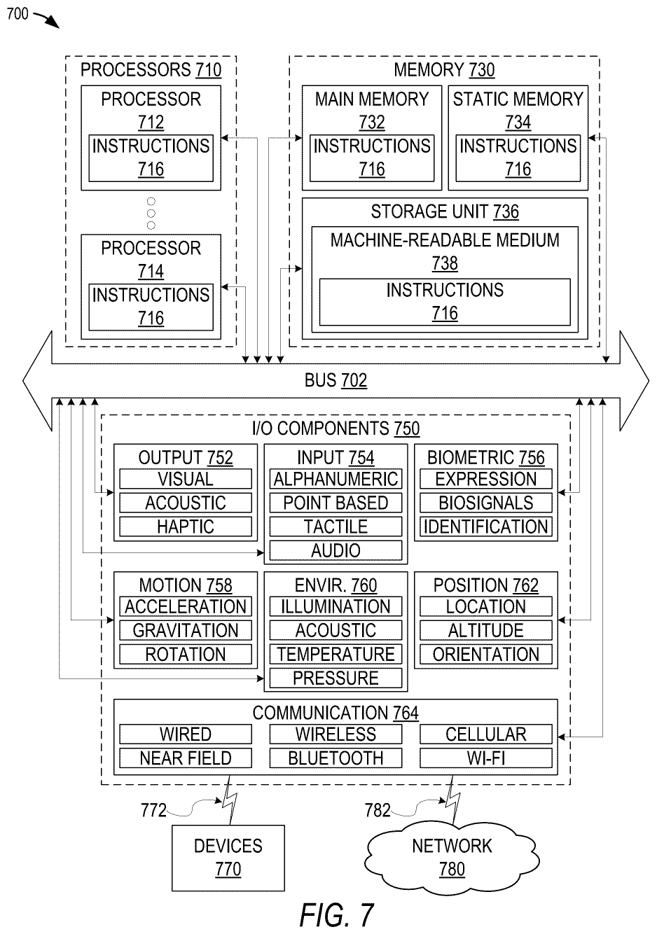

FIG. 6 is a block diagram 600 illustrating software architecture 602, which can be installed on any one or more of the devices described above. For example, in various embodiments, client devices 110 and servers and systems 130, 102, 120, 122, and 124 may be implemented using some or all of the elements of software architecture 602. FIG. 6 is merely a non-limiting example of a software architecture, and it will be appreciated that many other architectures can be implemented to facilitate the functionality described herein. In various embodiments, the software architecture 602 is implemented by hardware such as machine 700 of FIG. 7 that includes processors 710, memory 730, and I/O components 750. In this example, the software architecture 602 can be conceptualized as a stack of layers where each layer may provide a particular functionality. For example, the software architecture 602 includes layers such as an operating system 604, libraries 606, frameworks 608, and applications 610. Operationally, the applications 610 invoke application programming interface (API) calls 612 through the software stack and receive messages 614 in response to the API calls 612, consistent with some embodiments.

In various implementations, the operating system 604 manages hardware resources and provides common services. The operating system 604 includes, for example, a kernel 620, services 622, and drivers 624. The kernel 620 acts as an abstraction layer between the hardware and the other software layers, consistent with some embodiments. For example, the kernel 620 provides memory management, processor management (e.g., scheduling), component management, networking, and security settings, among other functionality. The services 622 can provide other common services for the other software layers. The drivers 624 are responsible for controlling or interfacing with the underlying hardware, according to some embodiments. For instance, the drivers 624 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 606 provide a low-level common infrastructure utilized by the applications 610. The libraries 606 can include system libraries 630 (e.g., C standard library) that can provide functions such as memory allocation functions, string manipulation functions, mathematic functions, and the like. In addition, the libraries 606 can include API libraries 632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and in three dimensions (3D) graphic content on a display), database libraries (e.g., SQLite to provide various relational database functions), web libraries (e.g., WebKit to provide web browsing functionality), and the like. The libraries 606 can also include a wide variety of other libraries 634 to provide many other APIs to the applications 610.

The frameworks 608 provide a high-level common infrastructure that can be utilized by the applications 610, according to some embodiments. For example, the frameworks 608 provide various graphic user interface (GUI) functions, high-level resource management, high-level location services, and so forth. The frameworks 608 can provide a broad spectrum of other APIs that can be utilized by the applications 610, some of which may be specific to a particular operating system 604 or platform.

In an example embodiment, the applications 610 include a home application 650, a contacts application 652, a browser application 654, a book reader application 656, a location application 658, a media application 660, a messaging application 662, a game application 664, and a broad assortment of other applications such as third-party applications 666 and 667. According to some embodiments, the applications 610 are programs that execute functions defined in the programs. Various programming languages can be employed to create one or more of the applications 610, structured in a variety of manners, such as object-oriented programming languages (e.g., Objective-C, Java, or C++) or procedural programming languages (e.g., C or assembly language). In a specific example, the third-party application 666 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 666 can invoke the API calls 612 provided by the operating system 604 to facilitate functionality described herein.

FIG. 7 is a block diagram illustrating components of a machine 700, according to some embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application 610, an applet, an app, or other executable code) for causing the machine 700 to perform any one or more of the methodologies discussed herein can be executed. In alternative embodiments, the machine 700 operates as a standalone device or can be coupled (e.g., networked) to other machines. In a networked deployment, the machine 700 may operate in the capacity of a server machine or system 130, 102, 120, 122, 124, etc., or a client device 110 in a server-client network environment, or as a peer machine in a peer-to-peer (or distributed) network environment. The machine 700 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

In various embodiments, the machine 700 comprises processors 710, memory 730, and I/O components 750, which can be configured to communicate with each other via a bus 702. In an example embodiment, the processors 710 (e.g., a central processing unit (CPU), a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) include, for example, a processor 712 and a processor 714 that may execute the instructions 716. The term “processor” is intended to include multi-core processors 710 that may comprise two or more independent processors 712, 714 (also referred to as “cores”) that can execute instructions 716 contemporaneously. Although FIG. 7 shows multiple processors 710, the machine 700 may include a single processor 710 with a single core, a single processor 710 with multiple cores (e.g., a multi-core processor 710), multiple processors 712, 714 with a single core, multiple processors 712, 714 with multiples cores, or any combination thereof.

The memory 730 comprises a main memory 732, a static memory 734, and a storage unit 736 accessible to the processors 710 via the bus 702, according to some embodiments. The storage unit 736 can include a machine-readable medium 738 on which are stored the instructions 716 embodying any one or more of the methodologies or functions described herein. The instructions 716 can also reside, completely or at least partially, within the main memory 732, within the static memory 734, within at least one of the processors 710 (e.g., within the processor's cache memory), or any suitable combination thereof, during execution thereof by the machine 700. Accordingly, in various embodiments, the main memory 732, the static memory 734, and the processors 710 are considered machine-readable media 738.

As used herein, the term “memory” refers to a machine-readable medium 738 able to store data temporarily or permanently and may be taken to include, but not be limited to, random-access memory (RAM), read-only memory (ROM), buffer memory, flash memory, and cache memory. While the machine-readable medium 738 is shown, in an example embodiment, to be a single medium, the term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 750 include a wide variety of components to receive input, provide output, produce output, transmit information, exchange information, capture measurements, and so on. In general, it will be appreciated that the I/O components 750 can include many other components that are not shown in FIG. 7. The I/O components 750 are grouped according to functionality merely for simplifying the following discussion, and the grouping is in no way limiting. In various example embodiments, the I/O components 750 include output components 752 and input components 754. The output components 752 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 754 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 750 include biometric components 756, motion components 758, environmental components 760, or position components 762, among a wide array of other components. For example, the biometric components 756 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 include acceleration sensor components (e.g., accelerometer), gravitation sensor components, rotation sensor components (e.g., gyroscope), and so forth. The environmental components 760 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 762 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 750 may include communication components 764 operable to couple the machine 700 to a network 780 or devices 770 via a coupling 782 and a coupling 772, respectively. For example, the communication components 764 include a network interface component or another suitable device to interface with the network 780. In further examples, communication components 764 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 770 may be another machine 700 or any of a wide variety of peripheral devices (e.g., a peripheral device coupled via a Universal Serial Bus (USB)).

Moreover, in some embodiments, the communication components 764 detect identifiers or include components operable to detect identifiers. For example, the communication components 764 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 764, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 780 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 716 are transmitted or received over the network 780 using a transmission medium via a network interface device (e.g., a network interface component included in the communication components 764) and utilizing any one of a number of well-known transfer protocols (e.g., Hypertext Transfer Protocol (HTTP)). Similarly, in other example embodiments, the instructions 716 are transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

Furthermore, the machine-readable medium 738 is non-transitory (in other words, not having any transitory signals) in that it does not embody a propagating signal. However, labeling the machine-readable medium 738 “non-transitory” should not be construed to mean that the medium is incapable of movement; the machine-readable medium 738 should be considered as being transportable from one physical location to another. Additionally, since the machine-readable medium 738 is tangible, the machine-readable medium 738 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
for each reference image of a plurality of reference images, performing operations comprising:
segmenting, using an image processing segmentation technique, each reference image of the plurality of reference images to identify individual items within each reference image; and
analyzing, using a large language model, the identified individual items within each reference image to generate a textual description of the reference image;
generating a set of vector embeddings by generating a vector embedding for each textual description of a respective reference image;
creating a style template index based on the set of vector embeddings;
receiving a query from a user device in at least one of a text format, an audio format, or an image format;
converting the query to a query vector embedding;
analyzing the query vector embedding to identify at least one matching style template in the style template index;
identifying items from a product catalog that correspond to items in the at least one matching style template; and
causing the identified items to be displayed on the user device as a personalized recommendation in response to the query.

2. The computer-implemented method of claim 1, wherein the textual description includes at least one of a style category, occasion, season, or color.

3. The computer-implemented method of claim 1, wherein the large language model is prompted to generate predefined categories for the textual description including at least one of a style category, an occasion category, a season category, a color category, a style element category, a complementary items category, or a style name category.

4. The computer-implemented method of claim 1, wherein the style template index contains style templates associated with a particular vendor's products.

5. The computer-implemented method of claim 1, wherein the product catalog is associated with a specific vendor and the personalized recommendation is limited to products available from the specific vendor.

6. The computer-implemented method of claim 1, wherein the query includes a request for items appropriate for a specified occasion and the identified items are associated with a specific occasion.

7. The computer-implemented method of claim 1, wherein identifying items from a product catalog that correspond to items in the at least one matching style template is performed using cosine similarity.

8. The computer-implemented method of claim 1, wherein analyzing, using a large language model, the identified individual items within each reference image to generate a textual description of the reference image comprises:
providing the identified individual items as input to the large language model; and
prompting the large language model with predefined categories to generate the textual description.

9. The computer-implemented method of claim 1, further comprising:
generating a vector embedding of each image corresponding to each identified individual item within each reference image; and
wherein generating the vector embedding for each textual description of a respective reference image comprises generating the vector embedding for each textual description and a vector embedding for each image corresponding to each identified individual item within each reference image.

10. The computer-implemented method of claim 1, wherein one vector embedding is generated based on the textual description and each image.

11. The computer-implemented method of claim 1, wherein a separate vector embedding is generated for each of the textual description and each image.

12. A system comprising:
a memory that stores instructions; and
one or more processors configured by the instructions to perform operations comprising:
for each reference image of a plurality of reference images, performing operations comprising:
segmenting, using an image processing segmentation technique, each reference image of the plurality of reference images to identify individual items within each reference image; and
analyzing, using a large language model, the identified individual items within each reference image to generate a textual description of the reference image;
generating a set of vector embeddings by generating a vector embedding for each textual description of a respective reference image;
creating a style template index based on the set of vector embeddings;
receiving a query from a user device in at least one of a text format, an audio format, or an image format;
converting the query to a query vector embedding;
analyzing the query vector embedding to identify at least one matching style template in the style template index;
identifying items from a product catalog that correspond to items in the at least one matching style template; and
causing the identified items to be displayed on the user device as a personalized recommendation in response to the query.

13. The system of claim 12, wherein the textual description includes at least one of a style category, occasion, season, or color.

14. The system of claim 12, wherein the large language model is prompted to generate predefined categories for the textual description including at least one of a style category, an occasion category, a season category, a color category, a style element category, a complementary items category, or a style name category.

15. The system of claim 12, wherein the style template index contains style templates associated with a particular vendor's products.

16. The system of claim 12, wherein the product catalog is associated with a specific vendor and the personalized recommendation is limited to products available from the specific vendor.

17. The system of claim 12, wherein the query includes a request for items appropriate for a specified occasion and the identified items are associated with a specific occasion.

18. The system of claim 12, wherein identifying items from a product catalog that correspond to items in the at least one matching style template is performed using cosine similarity.

19. The system of claim 12, wherein analyzing, using a large language model, the identified individual items within each reference image to generate a textual description of the reference image comprises:
providing the identified individual items as input to the large language model; and
prompting the large language model with predefined categories to generate the textual description.

20. A non-transitory computer-readable medium comprising instructions stored thereon that are executable by at least one processor to cause a computing device to perform operations comprising:
for each reference image of a plurality of reference images, performing operations comprising:
segmenting, using an image processing segmentation technique, each reference image of the plurality of reference images to identify individual items within each reference image; and
analyzing, using a large language model, the identified individual items within each reference image to generate a textual description of the reference image;
generating a set of vector embeddings by generating a vector embedding for each textual description of a respective reference image;
creating a style template index based on the set of vector embeddings;
receiving a query from a user device in at least one of a text format, an audio format, or an image format;
converting the query to a query vector embedding;
analyzing the query vector embedding to identify at least one matching style template in the style template index;
identifying items from a product catalog that correspond to items in the at least one matching style template; and
causing the identified items to be displayed on the user device as a personalized recommendation in response to the query.
